(19) United States
(12) Patent Application Publication
(10) Pub. No.: US 2002/0032243 A1
(43) Pub. Date: Mar. 14, 2002

(54) Novel inverse latices self-invertible with respect to fatty acid esters, and cosmetic, dermocosmetic, dermopharmaceutical or pharmaceutical compositions comprising them

(75) Inventors: Guy Tabacchi, Castres (FR); Jean-Pierre Boiteux, Saix (FR); Chantal Almaric, Blan (FR); Nelly Michel, Maisons Alfort (FR); Paul Mallo, Chatou (FR)

Correspondence Address: YOUNG & THOMPSON, 745 SOUTH 23RD STREET 2ND FLOOR, ARLINGTON, VA, 22202

(73) Assignee: SOCIETE D'EXPLOITATION DE PRODUITS POUR LES INDUSTRIES CHIMIQUES SEPPIC

(21) Appl. No.: 09/888,441

(22) Filed: Jun. 26, 2001

(30) Foreign Application Priority Data
Jun. 28, 2000 (FR) 000 8303

(51) Int. Cl. C09K 3/00

(52) U.S. Cl. 516/98

(57) ABSTRACT

Composition comprising an oil phase, an aqueous phase, at least one emulsifying agent of water-in-oil (W/O) type and at least one emulsifying agent of oil-in-water (O/W) type in the form of a self-invertible inverse latex comprising from 20% to 70% by weight and preferably from 25% to 50% by weight of a branched or crosslinked polyelectrolyte, characterized in that the said polyelectrolyte is either a homopolymer based on a monomer having either a partially or completely salified strong acid functional group or a partially or completely salified weak acid functional group, or a copolymer based on at least one monomer having a strong acid functional group copolymerized either with at least one monomer having a weak acid functional group or with at least one neutral monomer, or a copolymer based on at least one monomer having a weak acid functional group copolymerized with at least one neutral monomer, and characterized in that the constituent solvent of the oil phase is chosen from fatty acid esters. Cosmetic, dermocosmetic, dermopharmaceutical or pharmaceutical composition comprising it.

The present patent application relates to inverse water-in-oil latices, to their process of preparation and to their application as thickener and/or emulsifier for skincare and haircare products or for the manufacture of cosmetic, dermocosmetic, dermopharmaceutical or pharmaceutical preparations.

Synthetic thickening polymers, provided in the form of inverse latices, are disclosed as being able to be used in the manufacture of topical compositions in the French patent applications published under the numbers 2 721 511, 2 733 805, 2 774 688, 2 774 996 and 2 782 086 and in the European patent application published under the number EP 0 503 853.

However, some of them sometimes produce intolerance reactions with some types of sensitive skin.

That is why the Applicant Company has taken an interest in looking for novel polymer emulsions which are better tolerated by the skin than those of the state of the art.

A subject-matter of the invention is a composition comprising an oil phase, an aqueous phase, at least one emulsifying agent of water-in-oil (W/O) type and at least one emulsifying agent of oil-in-water (O/W) type in the form of a self-invertible inverse latex comprising from 20% to 70% by weight and preferably from 25% to 50% by weight of a branched or crosslinked polyelectrolyte, characterized in that the said polyelectrolyte is either a homopolymer based on a monomer having either a partially or completely salified strong acid functional group or a partially or completely salified weak acid functional group, or a copolymer based on at least one monomer having a strong acid functional group copolymerized either with at least one monomer having a weak acid functional group or with at least one neutral monomer, or a copolymer based on at least one monomer having a weak acid functional group copolymerized with at least one neutral monomer, and characterized in that the constituent solvent of the oil phase is chosen from fatty acid esters.

The term “fatty acid ester” is understood to mean, in the context of the present invention, a compound of formula (I):

R₁—(C═O)—O—[[CH₂—CH[O—[C(═O)]ₘ—R₂]—CH₂—O]ₙ—[C(═O)]ₚ]_{q}—R₃ (I)

in which:

R₁ represents a saturated or unsaturated and linear or branched hydrocarbonaceous chain comprising from 7 to 30 carbon atoms,

R₂ represents, independently of R₁, a hydrogen atom or saturated or unsaturated and linear or branched hydrocarbonaceous chain comprising from 7 to 30 carbon atoms,

R₃ represents, independently of R₁ or of R₂, a hydrogen atom or saturated or unsaturated and linear or branched hydrocarbonaceous chain comprising from 1 to 30 carbon atoms,

m, n, p and q are, independently of one another, equal to 0 or to 1, it being understood that, when R₃ represents a hydrogen atom, q is other than 0.

In the formula (I) as defined above, R₁, R₂ and R₃ in particular represent, independently of one another, a radical chosen from the heptyl, octyl, nonyl, decyl, undecyl, dodecyl, tridecyl, tetradecyl, pentadecyl, hexadecyl, heptadecyl, octadecyl, nonadecyl, icosyl, unicosyl, docosyl, heptadecenyl, icosenyl, unicosenyl, docosenyl or heptadecadienyl or decenyl radicals; and the R₁—C(═O)— group more particularly represents one of the octanoyl (caprylyl), decanoyl, undecylenoyl, dodecanoyl (lauroyl), tetradecanoyl (myristyl), hexadecanoyl (palmitoyl), octadecanoyl (stearyl), icosanoyl (arachidoyl), docosanoyl (behenoyl), 8-octadecenoyl (oleyl), icosenoyl (gadoloyl), 13-docosenoyl (erucyl), 9,12-octadecadienoyl (linoleoyl) or 9,12,15-octa-decatrienoyl (linolenoyl) radicals.

According to a first specific aspect of the present invention, the constituent solvent of the oil phase of the inverse latex is a compound of formula (Ia):

R₁—(C═O)—O—CH₂—CH[O—[C(═O)]ₘ—R₂]—CH₂—O—[C(═O)]ₚ—R₃ (Ia)

corresponding to the formula (I) as defined above in which q and n are equal to 1, or a mixture of compounds of formulae (Ia).

When the constituent solvent of the oil phase of the inverse latex is a compound of formula (Ia), it is preferably,

either a compound of formula (Ia₁):

R₁—(C═O)—O—CH₂—CH(OH)—CH₂—OH (Ia₁)

corresponding to the formula (Ia) as defined above in which m and p are equal to 0 and R₂ and R₃ represent a hydrogen atom,

or a compound of formula (Ia₂):

R₁—(C═O)—O—CH₂—CH(OH)—CH₂—O—C(═O)—R₃ (Ia₂)

corresponding to the formula (Ia) as defined above in which p is equal 1, m is equal to 0 and R₂ represents a hydrogen atom,

or a compound of formula (Ia₃):

R₁—(C═O)—O—CH₂—CH[O—C(═O)—R₂]—CH₂—O—C(═O)—R₃ (Ia₃)

corresponding to the formula (Ia) as defined above in which m and p are equal to 1,

or a mixture of compounds of formulae (Ia₁), (Ia₂) and/or (Ia₃).

Examples [lacuna] compounds of formulae (Ia₁), (Ia₂) or (Ia₃) include, for example, triglycerides of fatty acids or of mixtures of fatty acids, such as the mixture of triglycerides of fatty acids comprising from 6 to 10 carbon atoms sold under the name Softenol™ 3819, the mixture of triglycerides of fatty acids comprising from 8 to 10 carbon atoms sold under the name Softenol™ 3108, the mixture of triglycerides of fatty acids comprising from 8 to 16 carbon atoms sold under the name Softenol™ 3178, the mixture of triglycerides of fatty acids comprising from 12 to 18 carbon atoms sold under the name Softenol™ 3100, the mixture of triglycerides of fatty acids comprising 7 carbon atoms sold under the name Softenol™ 3107, the mixture of triglycerides of fatty acids comprising 14 carbon atoms sold under the name Softenol™ 3114, or the mixture of triglycerides of fatty acids comprising 18 carbon atoms sold under the name Softenol™ 3118, glyceryl dilaurate, glyceryl dioleate, glyceryl isostearate, glyceryl distearate, glyceryl monolaurate, glyceryl monooleate, glyceryl monoisostearate, glyceryl monostearate, or a mixture of these compounds.

According to a second specific aspect of the present invention, the constituent solvent of the oil phase of the inverse latex is a compound of formula (Ib):

R₁—(C═O)—O—R₃ (Ib)

corresponding to the formula (I) as defined above in which q is equal to 0, or a mixture of compounds of formulae (Ib).

Examples of compounds of formula (Ib) include, for example, octyl palmitate.

According to a third specific aspect of the present invention, the constituent solvent of the oil phase of the inverse latex is a mixture of at least one compound of formula (Ib) and of at least one compound of formulae (Ia).

The term “branched polymer” denotes a nonlinear polymer which has pendant chains, so as to obtain a high state of entanglement when this polymer is dissolved in water, resulting in very high viscosities at a low gradient.

The term “crosslinked polymer” denotes a non-linear polymer which exists in the state of a three-dimensional network which is insoluble in water but swellable in water and which thus results in the production of a chemical gel.

The composition according to the invention can comprise crosslinked units and/or branched units.

The term “emulsifying agent of the water-in-oil type” denotes emulsifying agents having an HLB value which is sufficiently low to provide water-in-oil emulsions, such as the surface-active polymers sold under the name of Hypermer™ or such as sorbitan esters, for example the sorbitan monooleate sold by Seppic under the tradename of Montane™ 80 or the sorbitan isostearate sold by Seppic under the name of Montane™ 70. These emulsifying agents can also include the sorbitan oleate ethoxylated with 5 mol of ethylene oxide sold by Seppic under the name of Montanox™ 81.

The term “emulsifying agent of the oil-in-water type” denotes emulsifying agents having an HLB value which is sufficiently high to provide oil-in-water emulsions, such as ethoxylated sorbitan esters, for example the sorbitan oleate ethoxylated with 20 mol of ethylene oxide sold by Seppic under the name of Montanox™80, the ethoxylated castor oil comprising 40 mol of ethylene oxide sold by Seppic under the name of Simulsol™ OL50, the ethoxylated sorbitan laurate comprising 20 mol of ethylene oxide sold by Seppic under the name of Montanox™20 or the ethoxylated lauryl alcohol comprising 7 mol of ethylene oxide sold by Seppic under the name of Simulsol™ P7.

Emulsifying agents having an HLB value which is sufficiently high to provide oil-in-water emulsions also include the compounds of formula (II):

R₄—O—[CH(R₅)—CH₂—O]ₙ—(G)ₓ—H (II)

in which R₄ represents a saturated or unsaturated and linear or branched hydrocarbonaceous radical comprising from 1 to 30 carbon atoms, R₅ represents a hydrogen atom or an alkyl radical comprising 1 or 2 carbon atoms, G represents the residue of a saccharide, x represents a decimal number between 1 and 5 and n is equal either to zero or to an integer between 1 and 30.

The term “residue of a saccharide” denotes, for G, a bivalent radical resulting from the removal on a sugar molecule, on the one hand, of a hydrogen atom of a hydroxyl group and, on the other hand, of the anomeric hydroxyl group. The term “saccharide” denotes in particular glucose or dextrose, fructose, mannose, galactose, altrose, idose, arabinose, xylose, ribose, gulose, lyxose, maltose, maltotriose, lactose, cellobiose, dextran, talose, allose, raffinose, laevo-glucan, cellulose or starch. The oligomeric structure (G)ₓ can exist under any form of isomerism, whether optical isomerism, geometrical isomerism or positional isomerism. It can also represent a mixture of isomers. In the formula (II) as defined above, the radical R₄—O—[CH(R₅)—CH₂—O]ₙ— is bonded to G via the anomeric carbon, so as to form an acetal functional group. The divalent group —[CH(R₅)—CH₂—O]ₙ— represents either a chain composed solely of ethoxyl groups (R₅═H) or a chain composed solely of propoxyl groups (R₅═CH₃) or a chain composed both of ethoxyl groups and of propoxyl groups. In the latter case, the fragments —CH₂—CH₂—O—and —CH(CH₃)—CH₂—O— are distributed in the said chain in a block or random fashion. [lacuna] x, which represents, in the formula (II), the mean degree of polymerization of the saccharide, is more particularly between 1 and 3, in particular between 1.05 and 2.5, very particularly between 1.1 and 2.0 and preferably less than or equal to 1.5. Emulsifying surface-active agents having an HLB value which is sufficiently high to provide oil-in-water emulsions include more particularly the compounds in formula (II) as defined above in which G represents the glucose residue or the xylose residue and/or in which n is equal to 0 and/or in which R₄ represents a radical comprising from 8 to 18 carbon atoms and more particularly in which R₄ represents more particularly an octyl, decyl, undecyl, dodecyl, tetradecyl or hexadecyl radical, the said radicals being linear or branched.

Examples of commercial products comprising the said compounds include, for example:

Simulsol™SL8, sold by Seppic, which is an aqueous solution comprising between approximately 35% and 45% by weight of a mixture of alkyl polyglycosides consisting of between 45% by weight and 55% by weight of a compound of formula (II) in which G represents the glucose residue, x is equal to about 1.45, n is equal to 0 and R₄ represents a decyl radical and between 45% by weight and 55% by weight of a compound of formula (II) in which G represents the glucose residue, x is equal to approximately 1.45, n is equal to 0 and R₄ represents an octyl radical;

Simulsol™ SL10, sold by Seppic, which is an aqueous solution comprising between approximately 40% and weight and 50% by weight of a mixture of alkyl polyglycosides consisting of approximately 85% by weight of a compound of formula (II) in which G represents the glucose residue, x is equal to approximately 1.45, n is equal to 0 and R₄ represents a decyl radical, approximately 7.5% by weight of a compound of formula (II) in which G represents the glucose residue, x is equal to approximately 1.45, n is equal to 0 and R₄ represents a dodecyl radical and approximately 7.5% by weight of a compound of formula (II) in which G represents the glucose residue, x is equal to approximately 1.45, n is equal to 0 and R₄ represents a tetradecyl radical;

Simulsol™ SL11, sold by Seppic, which is an aqueous solution comprising between approximately 40% and weight and 50% by weight of a mixture of alkyl polyglycosides of formula (II) in which G represents the glucose residue, x is equal to approximately 1.45, n is equal to 0 and R₄ represents an undecyl radical; or

Simulsol™ SL26, sold by Seppic, which is an aqueous solution comprising between approximately 40% and weight and 55% by weight of a mixture of alkyl polyglycosides consisting of approximately 70% by weight of a compound of formula (II) in which G represents the glucose residue, x is equal to approximately 1.45, n is equal to 0 and R₄ represents a dodecyl radical, approximately 25% by weight of a compound of formula (II), in which G represents the glucose residue, x is equal to approximately 1.45, n is equal to 0 and R₄ represents a tetradecyl radical and approximately 5% by weight of a compound of formula (II) in which G represents the glucose residue, x is equal to approximately 1.45, n is equal to 0 and R₄ represents a hexadecyl radical.

The strong acid functional group of the monomer comprising it is in particular the sulphonic acid functional group or the phosphonic acid functional group, partially or completely salified. The said monomer can be, for example, partially or completely salified styrenesulphonic acid. It is preferably 2-methyl-2-[(1-oxo-2-propenyl)amino]-1-propanesulphonic acid, partially or completely salified in the form of an alkali metal salt, such as, for example, the sodium salt or the potassium salt, of the ammonium salt, of a salt of an aminoalcohol, such as, for example, the monoethanolamine salt, or of an amino acid salt, such as, for example, the lysine salt.

The weak acid functional group of the monomer comprising it is in particular the carboxylic acid functional group and the said monomer is preferably chosen from partially or completely salified acrylic acid, methacrylic acid, itaconic acid or maleic acid.

The neutral monomer is chosen in particular from acrylamide, 2-hydroxyethyl acrylate, 2,3-dihydroxypropyl acrylate, 2-hydroxyethyl methacrylate, 2,3-dihydroxypropyl methacrylate or an ethoxylated derivative with a molecular weight of between 400 and 1 000 of each of these esters.

According to a fourth specific aspect of the present invention, the polyelectrolyte included in the inverse latex as defined above is a homopolymer of acrylic acid partially or completely salified in the form of the sodium or of the ammonium salt.

According to a fifth specific aspect of the present invention, the polyelectrolyte included in the inverse latex as defined above is a copolymer of partially or completely salified 2-methyl-2-[(1-oxo-2-propenyl)-amino]-1-propanesulphonic acid (a) and of 2-hydroxyethyl acrylate (b) in an (a)/(b) molar ratio of between 30/70 and 90/10 and very particularly 50/50 and 90/10. The polyelectrolyte is preferably a copolymer of the sodium salt or of the ammonium salt of 2-methyl-2-[(1-oxo-2-propenyl)amino]-1-propanesulphonic acid (a₁) and of 10% to 40% of 2-hydroxyethyl acrylate (b) in an (a₁)/(b) molar ratio of between 60/40 and 90/10.

According to a sixth specific aspect of the present invention, the polyelectrolyte included in the inverse latex as defined above is a copolymer of the sodium salt, of the ammonium salt, of the monoethanolamine salt or of the lysine salt of 2-methyl-2-[(1-oxo-2-propenyl)amino]-1-propanesulphonic acid (a₁) and of acrylic acid partially or completely salified in the form of the sodium salt, of the ammonium salt, of the monoethanolamine salt or of the lysine salt (c₁) in an (a₁)/(c₁) molar ratio of between 30/70 and 90/10 and very particularly between 30/70 and 45/55.

According to a seventh specific aspect of the present invention, the polyelectrolyte included in the inverse latex as defined above is a copolymer of the sodium salt or of the ammonium salt of 2-methyl-2-[(1-oxo-2-propenyl)amino]-1-propanesulphonic acid (a₂) and of acrylamide (d) in an (a₂)/(d) molar ratio of between 50/50 and 30/70.

A subject-matter of the invention is, more particularly, a composition as defined above, characterized in that the polyelectrolyte is crosslinked and/or branched with a diethylenic or polyethylenic compound in the molar proportion, expressed with respect to the monomers employed, of 0.005% to 1%, more particularly of 0.01% to 0.5% and very particularly of 0.1% to 0.25%. The crosslinking agent and/or the branching agent is chosen from diallyloxyacetic acid or one of its salts, such as sodium diallyloxyacetate, ethylene glycol dimethacrylate, ethylene glycol diacrylate, diallylurea, trimethylolpropane triacrylate, methylenebis(acrylamide), triallylamine or a mixture of these compounds.

The inverse latex as defined above generally comprises from 4% to 10% by weight of emulsifying agents. Generally, from 20% to 50% and more particularly from 25% to 40% of the total weight of the emulsifiers are of the water-in-oil type and from 80% to 50% and more particularly from 75 to 60% are of the oil-in-water type.

Its oil phase represents from 15% to 40% and preferably from 20% to 25% of its total weight. This latex can additionally comprise one or more additives chosen in particular from complexing agents, transfer agents or chain-limiting agents.

Another subject-matter of the invention is a cosmetic, [lacuna] dermopharmaceutical or pharmaceutical composition, characterized in that it comprises at least one thickening compound, at least one inverse latex as defined above.

The cosmetic, dermocosmetic, dermopharmaceutical or pharmaceutical composition defined above generally comprises from 0.1% to 10% and more particularly between 0.5% and 5% by weight of the said inverse latex. It is provided in particular in the form of a milk, of a lotion, of a gel, of a cream, of a soap, of a foam bath, of a balm, of a shampoo or of a conditioner.

Generally, the said inverse latex can advantageously replace the products sold under the name Sepigel™ 305 or Sepigel™ 501 by the Applicant Company in cosmetic, dermopharmaceutical or pharmaceutical compositions as it also exhibits good compatibility with the other excipients used in the preparation of formations such as milks, lotions, creams, soaps, [lacun1a] baths, balms, shampoos or conditioners. It can also be used in combination [lacuna] the said Sepigel products. It is in particular compatible with the concentrates disclosed and claimed in international publications WO 92/06778, WO 95/04592, WO 95/13863 or FR 2 734 496 or with the surface-active agents disclosed in WO 93/08204.

It is particularly compatible with Montanov™ 68, Montanov™ 82, Montanov™ 202, Montanov™ WO18, Montanov™ S or Sepiperl™ N. It can also be used in emulsions of the type of those disclosed and claimed in EP 0 629 396 and in cosmetically or physiologically acceptable aqueous dispersions with an organopolysiloxane compound chosen, for example, from those disclosed in WO 93/05762 or in WO 93/21316. It can also be used to form cosmetically or physiologically acceptable aqueous gels with an acidic pH, such as those disclosed in WO 93/97856; it can also be used in combination with nonionic celluloses to form, for example, styling gels, such as those disclosed in EP 0 684 024, or in combination with esters of fatty acids and of sugar to form compositions for the treatment of the hair or of the skin, such as those disclosed in EP 0 603 019, or in shampoos or conditioners, such as disclosed and claimed in WO 92/21316, or finally in combination with an anionic homopolymer, such as Carbopol™, to form hair treatment products, such as those disclosed in DE 195 23596. It is also compatible with numerous active principles, such as, for example, self-tanning agents, such as dihydroxyacetone (DHA), or anti-acne agents; it can thus be introduced into self-tanning compositions, such as those claimed in EP 0 715 845, EP 0 604 249 or EP 0 576 188 or in WO 93/07902. It is also compatible with N-acylated derivatives of amino acids, which allows it to be used in soothing compositions, in particular for sensitive skin, such as those disclosed or claimed in WO 92/21318, WO 94/27561 or WO 98/09611. It is also compatible with glycolic acids, with lactic acid, with salicylic acid, retinoids, phenoxyethanol, sugars, glyceraldehyde, xanthans, fruit acids and the various polyols used in the manufacture of cosmetic formulations.

Another subject-matter of the invention is thus the use of an inverse latex as defined above in preparing a cosmetic, dermocosmetic, dermopharmaceutical or pharmaceutical composition.

The examples which follow have the aim of illustrating the present invention without, however, limiting it. They show that the novel inverse latices do not irritate the skin and that their physical properties allow them to be used in the preparation of cosmetic, dermopharmaceutical or pharmaceutical compositions intended more particularly for the treatment of sensitive skin.

### A) Examples of preparations of compositions according to the invention

### Example 1

### Inverse latex of an AMPS (Na salt)/acrylic acid (Na salt) copolymer crosslinked with methylenebis(acryl-amide) in octyl palmitate (Composition 1)

a) The following are charged to a reactor with stirring:

2.88 kg of glacial acrylic acid,

22.05 kg of a commercial 55% solution of sodium 2-methyl-2-[(1-oxo-2-propenyl)amino]-1-propane-sulphonate,

1.66 kg of a 48% by weight aqueous sodium hydroxide solution,

0.022 kg of sodium diethylenetriamine-pentaacetate,

0.006 kg of methylenebis(acrylamide).

The pH of this aqueous solution is 4.9; 7.42 kg of water are added.

b) An organic phase is prepared by mixing:

5.28 kg of Isopar™ G,

4.875 kg of octyl palmitate,

1.416 kg of Montane™ 80 VG,

0.377 kg of Montanox™ 81 VG and

0.0078 kg of azobis(isobutyronitrile).

c) The aqueous phase is gradually introduced into the organic phase and the combined mixture is vigorously stirred by means of Silverson™ stirrer.

The emulsion obtained is then transferred into a polymerization reactor, subjected to nitrogen sparging and then cooled to approximately 5-6° C. 250 ml of a solution comprising 0.635% by weight of cumene hydroperoxide in Isopar™ G are then added and then, after homogenizing the solution, an aqueous sodium metabisulphite solution (0.2% by weight in water) is added at the rate of 0.2 ml/minute over approximately 80 minutes while allowing the temperature to rise to the polymerization temperature. The reaction medium is then maintained for approximately 90 minutes at this temperature, on conclusion of which the mixture obtained is heated under partial vacuum to remove the Isopar™ G and approximately 10 kg of water. The resulting mixture is cooled to approximately 35°. 2.53 kg of ethoxylated sorbitan oleate comprising 20 mol [lacuna] (Montanox™ 80) are slowly introduced and the desired water-in-oil emulsion is obtained.

Evaluation of the Properties

Viscosity in water at 3% of the latex (Brookfield RVT, Rotor 6, speed 5): η=50 200 mPas

Viscosity at 3% of latex in saline water comprising 0.1% of NaCl (Brookfield RVT, Rotor 6, speed 5): η=25 800 mPas.

### Example 2

### Inverse latex of an AMPS (Na salt)/acrylic acid (Na salt) copolymer crosslinked with methylenebis(acrylamide) in a mixture of triglyceride of fatty acids comprising 8 carbon atoms (Composition 2)

a) The following are charged to a beaker with stirring:

55.86 g of glacial acrylic acid,

428.25 g of a commercial 55% solution of sodium 2-methyl-2-[(1-oxo-2-propenyl)amino]-1-propane-sulphonate,

32.34 g of a 48% by weight aqueous sodium hydroxide solution,

0.40 g of sodium diethylenetriaminepentaacetate,

0.106 g of methylenebis(acrylamide).

The pH of this aqueous solution is 4.9 and deionized water is added so as to bring the mass of the aqueous phase to 625.61 g.

b) An organic phase is prepared by mixing:

57.1 g of Isopar™ G,

228.25 g of triglyceride of C₈—C₁₀ fatty acids sold in France by Stearinerie Dubois & Fils under the name Triglycerides C₈C₁₀5545,

8.83 g of Hypermer™ B246 (octadecene/maleic anhydride copolymer sold by Chevron Chemicals),

1.47 g of PA-18 resin and

0.26 g of azobis(isobutyronitrile).

c) The aqueous phase is gradually introduced into the organic phase and the combined mixture is vigorously stirred by means of an Ultra-Turrax™ stirrer sold by IKA. The emulsion obtained is then transferred into a polymerization reactor, subjected to nitrogen sparging and then cooled to approximately 5-6° C. 5 ml of a solution comprising 0.384% by weight of cumene hydroperoxide in Isopar™ G are then added and then, after homogenizing the solution, an aqueous sodium metabisulphite solution (0.1% in water) is added over approximately 60 minutes while allowing the temperature to rise to the polymerization temperature. The reaction medium is then maintained for approximately 90 minutes at this temperature, on conclusion of which the mixture obtained is heated under partial vacuum to remove the Isopar™ G and approximately 10 kg of water. The mixture obtained is cooled to approximately 35°. 10.1 kg of ethoxylated castor oil comprising 40 mol of ethylene oxide (Simulsol™ OL50) are slowly introduced and the desired water-in-oil emulsion is obtained.

Evaluation of the Properties

Viscosity in water at 3% of the latex (Brookfield RVT, Rotor 6, speed 5): η=106 000 mPas

Viscosity at 3% of latex + in saline water (0.1% NaCl) (Brookfield RVT, Rotor 6, speed 5): η=37 000 mPas.

### B) Properties of the compositions according to the invention

a) Temperature stability

A cream gel comprising 3% of Composition 1 and 20% of cetearyl octanoate was prepared and the viscosity was measured. The results are as follows.

Viscosity, Brookfield LVT, 6 rpm (in
mPas)

| | At ambient temperature | At 50° C. |
|---|---|---|
| After 1 day | 100 000 | 100 000 |
| After 7 days | 100 000 | 100 000 |
| After 1 month | 100 000 | 100 000 |

b) Influence of UV radiation on the stability

It is found that the gels prepared with Compositions 1 or 2 are very stable towards UV radiation, their viscosities not having varied after exposure for 14 days.

c) Influence of the pH on the viscosity

The viscosities of the gels prepared with Compositions 1 or 2 [lacuna] very stable to pH in the range pH = 4 to pH = 8.

d) Comparative study of tolerance

The local epicutaneous tolerance of a series of cream gels, comprising 3% and 5% by weight of one of Compositions 1 to 7 prepared as described above, was determined and compared with that observed with an inverse latex of an AMPS/sodium acrylate copolymer crosslinked with methylenebis(acrylamide) in isohexadecane (Composition A), according to the following protocol:

The test composition is applied [lacuna] an area of approximately 50 mm² of the left subcapular region of the skin of the backs of 38 healthy volunteers, including 19 with a skin of “Japanese skin” (JS) “type type and 19 with a skin of “Caucasian skin” (CS) type. Contact is maintained for 48 hours under an occlusive patch.

This application is also carried out under the same conditions with a patch alone (without composition) as negative control.

Clinical observation of the skin area thus treated is carried out 30 minutes and then 24 hours after removing the said patches. These observations are made by comparison with the untreated negative control area.

Quantification of the cutaneous irritation, according to a numerical scale ranging from 0 to 4 (0: no effect; 1: very slight effect; 2: distinct effect; 3 and 4: moderate to severe effect depending on the reactions), is carried out for each of the reactions possibly observed, namely: erythema, oedema, blisters, dryness of the skin, roughness of the skin and reflectivity of the skin.

The cutaneous tolerance indices (CI) given in the following table express the mean of the sum of the quantified effects recorded for each volunteer:

CI=0 means that no irritation was observed,

CI<0.5 means that the product is statistically well tolerated,

CI>0.5 means that the product results in intolerance. (Composition A).

Cutaneous tolerance index of 5%
gels

| | JS | CS |
|---|---|---|
| Composition 1 | 0.05 | 0.0 |
| Composition 2 | 0.00 | 0.0 |
| Composition A | 0.95 | 0.47 |

These results show that, unexpectedly, octyl palmitate and the triglyceride of fatty acids of the composition prepared in Example 2 potentiating cutaneous tolerance of the polymer of the inverse latex.

### C) Examples of formulations prepared with the compositions according to the invention

### Example 3

Care Cream

| | |
|---|---|
| Cyclomethicone: | 10% |
| Composition 1: | 0.8% |
| Montanov ™ 68: | 2% |
| Stearyl alcohol: | 1% |
| Stearic alcohol: | 0.5% |
| Preservative: | 0.65% |
| Lysine: | 0.025% |
| EDTA (disodium salt): | 0.05% |
| Xanthan gum: | 0.2% |
| Glycerol: | 3% |
| Water: | q.s. for 100% |

### Example 4

Aftershave Balm

| | FORMULA | |
|---|---|---|
| A | Composition 1: | 1.5% |
| | Water: | q.s. for 100% |
| B | Micropearl ™ M100: | 5.0% |
| | Sepicide ™ CI: | 0.50% |
| | Fragrance: | 0.20% |
| | 95° Ethanol: | 10.0% |
| | PROCEDURE | |
| | B is added to A. | |

### Example 5

Satin Emulsion for the Body

| | FORMULA | |
|---|---|---|
| A | Simulsol ™ 165: | 5.0% |
| | Lanol ™ 1688: | 8.50% |
| | Karite butter: | 2% |
| | Liquid paraffin: | 6.5% |
| | Lanol ™ 14 M: | 3% |
| | Lanol ™ S: | 0.6% |
| B | Water: | 66.2% |
| C | Micropearl ™ M 100: | 5% |
| D | Composition 2: | 3% |
| E | Sepicide ™ CI: | 0.3% |
| | Sepicide ™ HB: | 0.5% |
| | Monteine ™ CA: | 1% |
| | Fragrance: | 0.20% |
| | Vitamin E acetate: | 0.20% |
| | Sodium pyrolidinonecarboxylate: | 1% |

PROCEDURE
C is added to B, B is emulsified in A at 70° C.,
D is then added at 60° C. and then E is added at 30° C..

### Example 6

O/W Cream

| | FORMULA | |
|---|---|---|
| A | Simulsol ™ 165: | 5.0% |
| | Lanol ™ 1688: | 20.0% |
| | Lanol ™ P: | 1.0% |
| B | Water: | q.s. for 100% |
| C | Composition 2: | 2.50% |
| E | Sepicide ™ CI: | 0.20% |
| | Sepicide ™ HB: | 0.30% |

PROCEDURE
B is introduced into A at approximately 75° C., C
is added at approximately 60° C. and then D is
added at approximately 45° C..

### Example 7

Non-Greasy Antisun Gel

| | FORMULA | |
|---|---|---|
| A | Composition 2: | 3.00% |
| | Water: | 30% |
| B | Sepicide ™ CI: | 0.20% |
| | Sepicide ™ HB: | 0.30% |
| | Fragrance: | 0.10% |
| C | Colorant: | q.s. for |
| | Water: | 30% |
| D | Micropearl ™ M 100: | 3.00% |
| | Water: | q.s. for 100% |
| E | Silicone oil: | 2.0% |
| | Parsol ™ MCX: | 5.00% |

PROCEDURE
B is introduced into A, C is added, then D is
added and then E is added.

### Example 8

Antisun Milk

| | FORMULA | |
|---|---|---|
| A | Montanov ™ S: | 3.0% |
| | Sesame oil: | 5.0% |
| | Parsol ™ MCX: | 5.0% |
| | λ-Carrageenan: | 0.10% |
| B | Water: | q.s. for 100% |
| C | Composition 1: | 0.80% |
| D | Fragrance: | q.s. |
| | Preservative: | q.s. |

PROCEDURE
B is emulsified in A at 75° C., then C is added
at approximately 60° C., then D is added at
approximately 30° C. and the pH is adjusted,
if necessary.

### Example 9

Massage Gel

| | FORMULA | |
|---|---|---|
| A | Composition 2: | 3.5% |
| | Water: | 20.0% |
| B | Colorant: | 2 drops/100 g |
| | Water: | q.s. |
| C | Alcohol: | 10% |
| | Menthol: | 0.10% |
| D | Silicone oil: | 5.0% |

PROCEDURE
B is added to A, then C is added to the mixture
and then D is added to the mixture.

### Example 10

Moisturizing and Mattifying Foundation

| | FORMULA | |
|---|---|---|
| A | Water: | 20.0% |
| | Butylene glycol: | 4.0% |
| | PEG-400: | 4.0% |
| | Pecosil ™ PS100: | 1.0% |
| | NaOH: | q.s. pH = 9 |
| | Titanium dioxide: | 7.0% |
| | Talc: | 2.0% |
| | Yellow iron oxide: | 0.8% |
| | Red iron oxide: | 0.3% |
| | Black iron oxide: | 0.05% |
| B | Lanol ™ 99: | 8% |
| | Caprylic/capric triglyceride | 8% |
| | Montanov ™ 202: | 5.00% |
| C | Water: | q.s. for 100% |
| | Micropearl ™ M305: | 2.0% |
| | Tetrasodium EDTA: | 0.05% |
| D | Cyclomethicone: | 4.0% |
| | Xanthan gum: | 0.2% |
| | Composition 1: | 0.8% |
| E | Sepicide ™ HB: | 0.5% |
| | Sepicide CI: | 03% |
| | Fragrance: | 0.2% |

PROCEDURE
The B + D and A + C mixtures are prepared at
80° C. and then all the ingredients are mixed and
emulsified.

### Example 11

Radiance Gel

| | | |
|---|---|---|
| | FORMULA | |
| A | Composition 1: | 4% |
| | Water: | 30% |
| B | Elastine HPM: | 5.0% |
| C | Micropearl™ M 100: | 3% |
| | Water: | 5% |
| D | Sepicide™ CI: | 0.2% |
| | Sepicide™ HB: | 0.3% |
| | Fragrance: | 0.06% |
| | 50% sodium pyrolidinonecarboxylate: | 1% |
| | Water: | q.s. for 100% |
| | PROCEDURE | |

A is prepared, B is added, then C is added and
then D is added.

### Example 12

Body Milk

| FORMULA | |
|---|---|
| Montanov™ S: | 3.5% |
| Lanol™ 37T: | 8.0% |
| Solagum™ L: | 0.05% |
| Water: | q.s. for 100% |
| Benzophenone: | 2.0% |
| Dimethicone 350 cPs: | 0.05% |
| Composition 2: | 0.8% |
| Preservative: | 0.2% |
| Fragrance: | 0.4% |

### Example 13

Make-Up-Removing Emulsion Comprising Sweet Almond Oil

| FORMULA | |
|---|---|
| Montanov™ 68: | 5% |
| Sweet almond oil: | 5% |
| Water: | q.s. for 100% |
| Composition 1: | 0.3% |
| Glycerol: | 5% |
| Preservative: | 0.2% |
| Fragrance: | 0.3% |

### Example 14

Moisturizing Cream for Greasy Skin

| FORMULA | |
|---|---|
| Montanov™ 68: | 5% |
| Cetylstearyl octanoate: | 8% |
| Octyl palmitate: | 2% |
| Water: | q.s. for 100% |
| Composition 2: | 0.6% |
| Micropearl™ M100: | 3.0% |
| Mucopolysaccharides: | 5% |
| Sepicide™ HB: | 0.8% |
| Fragrance: | 0.3% |

### Example 15

Alcohol-Free Soothing Aftershave Balm

| | FORMULA | |
|---|---|---|
| A | Lipacide™ PVB: | 1.0% |
| | Lanol™ 99: | 2.0% |
| | Sweet almond oil: | 0.5% |
| B | Composition 1: | 3.5% |
| C | Water: | q.s. for 100% |
| D | Fragrance: | 0.4% |
| | Sepicide™ HB: | 0.4% |
| | Sepicide™ CI: | 0.2% |

### Example 16

Cream With AHAs for Sensitive Skin

| FORMULA | |
|---|---|
| Mixture of lauryl amino acids: | 0.1% to 5% |
| Magnesium potassium aspartate: | 0.002% to 0.5% |
| Lanol™ 99: | 2% |
| Montanov™ 68: | 5.0% |
| Water: | q.s. for 100% |
| Composition 2: | 1.50% |
| Gluconic acid: | 1.50% |
| Triethylamine: | 0.9% |
| Sepicide™ HB: | 0.3% |
| Sepicide™ CI: | 0.2% |
| Fragrance: | 0.4% |

### Example 17

Aftersun Soothing Care Preparation

| FORMULA | |
|---|---|
| Mixture of lauryl amino acids: | 0.1% to 5% |
| Magnesium potassium aspartate: | 0.002% to 0.5% |
| Lanol™ 99: | 10.0% |
| Water: | q.s. for 100% |
| Composition 1: | 2.50% |
| Sepicide™ HB: | 0.3% |
| Sepicide™ CI: | 0.2% |
| Fragrance: | 0.4% |
| Colorant: | 0.03% |

### Example 18

Make-Up-Removing Milk

| FORMULA | |
|---|---|
| Sepiperl™ N: | 3% |
| Primol™ 352: | 8.0% |
| Sweet almond oil: | 2% |
| Water: | q.s. for 100% |
| Composition 2: | 0.8% |
| Preservative: | 0.2% |

### Example 19

Fluid Emulsion With an Alkaline pH

| | |
|---|---|
| Marcol™ 82: | 5.0% |
| NaOH: | 10.0% |
| Water: | q.s. for 100% |
| Composition 1: | 1.5% |

### Example 20

Liquid Foundation

| FORMULA | |
|---|---|
| Simulsol™ 165: | 5.0% |
| Lanol™ 84D: | 8.0% |
| Lanol™ 99: | 5.0% |
| Water: | q.s. for 100% |
| Inorganic pigments and fillers: | 10.0% |
| Composition 1: | 1.2% |
| Preservative: | 0.2% |
| Fragrance: | 0.4% |

### Example 21

Antisun Milk

| FORMULA | |
|---|---|
| Sepiperl ™ N: | 3.5% |
| Lanol ™ 37T: | 10.0% |
| Parsol ™ MCX: | 5.0% |
| Eusolex ™ 4360: | 2.0% |
| Water: | q.s. for 100% |
| Composition 1: | 1.8% |
| Preservative: | 0.2% |
| Fragrance: | 0.4% |

### Example 22

Eye Contour Gel

| FORMULA | |
|---|---|
| Composition 1: | 2.0% |
| Fragrance: | 0.06% |
| Sodium pyrrolidinonecarboxylate: | 0.2% |
| Dow Corning ™ 245 Fluid: | 2.0% |
| Water: | q.s. for 100% |

### Example 23

Leave-On Care Composition

| FORMULA | |
|---|---|
| Composition 1: | 1.5% |
| Fragrance: | q.s. |
| Preservative: | q.s. |
| Dow Corning ™ X2 8360: | 5.0% |
| Dow Corning ™ Q2 1401: | 15.0% |
| Water: | q.s. for 100% |

### Example 24

Slimming Gel

| | |
|---|---|
| Composition 1: | 5% |
| Ethanol: | 30% |
| Menthol: | 0.1% |
| Caffeine: | 2.5% |
| Ruscus extract: | 2% |
| Ivy extract: | 2% |
| Sepicide ™ HP: | 1% |
| Water: | q.s. for 100% |

### Example 25

Ultranatural Tinted Cream Gel

| | FORMULA | |
|---|---|---|
| A | Water: | 10.0% |
| | Butylene glycol: | 4.0% |
| | PEG-400: | 4.0% |
| | Pecosil ™ PS100: | 1.5% |
| | NaOH: | q.s. pH = 7 |
| | Titanium dioxide: | 2.0% |
| | Yellow iron oxide: | 0.8% |
| | Red iron oxide: | 0.3% |
| | Black iron oxide: | 0.05% |
| B | Lanol ™ 99: | 4.0% |
| | Caprylic/capric triglyceride: | 4.0% |
| | Sepifeel ™ ONE: | 1.0% |
| | Composition 1: | 3.0% |
| C | Water: | q.s. for 100% |
| | Micropearl ™ M305: | 2.0% |
| | Tetrasodium EDTA: | 0.05% |
| | Cyclomethicone: | 4.0% |
| D | Sepicide ™ HB: | 0.5% |
| | Sepicide ™ CI: | 03% |
| | Fragrance: | 0.2% |

Procedure

The B+C mixture is prepared, then A is added and then D is added.

### Example 26

Care Preparation for Greasy Skin

| | FORMULA | |
|---|---|---|
| A | Micropearl ™ M310: | 1.0% |
| | Composition 1: | 5.0% |
| | Octyl isononanoate: | 4.0% |
| B | Water: | q.s. for 100% |
| C | Sepicontrol ™ A5: | 4.0% |
| | Fragrance: | 0.1% |
| | Sepicide ™ HB: | 0.3% |
| | Sepicide ™ CI: | 0.2% |
| D | Capigel ™ 98: | 0.5% |
| | Water: | 10% |

### Example 27

Cream Comprising AHAs

| | FORMULA | |
|---|---|---|
| A | Montanov ™ 68: | 5.0% |
| | Lipacide ™ PVB: | 1.05% |
| | Lanol ™ 99: | 10.0% |
| B | Water: | q.s. for 100% |
| | Gluconic acid | 1.5% |
| | TEA (triethanolamine): | 0.9% |
| C | Composition 2: | 1.5% |
| D | Fragrance: | 0.4% |
| | Sepicide ™ HB: | 0.2% |
| | Sepicide ™ CI: | 0.4% |

### Example 28

Non-Greasy Self-Tanning Preparation for the Face and Body

| | FORMULA | |
|---|---|---|
| A | Lanol ™ 2681: | 3.0% |
| | Composition 1: | 2.5% |
| B | Water: | q.s. for 100% |
| | Dihydroxyacetone: | 3.0% |
| C | Fragrance: | 0.2% |
| | Sepicide ™ HB: | 0.8% |
| | NaOH (sodium hydroxide): | q.s. pH = 5 |

### Example 29

Anti-Sun Milk Comprising Tahitian Perfumed Oil

| | FORMULA | |
|---|---|---|
| A | Tahitian perfumed oil | 10% |
| | Lipacide ™ PVB: | 0.5% |
| | Composition 2: | 2.2% |
| B | Water: | q.s. for 100% |
| C | Fragrance: | 0.1% |
| | Sepicide ™ HB: | 0.3% |
| | Sepicide ™ CI: | 0.1% |
| | Parsol ™ MCX: | 4.0% |

### Example 30

Antisun Care Preparation for the Face

| | FORMULA | |
|---|---|---|
| A | Cyclomethicone and dimethiconol: | 4.0% |
| | Composition 2: | 3.5% |
| B | Water: | q.s. for 100% |
| C | Fragrance: | 0.1% |
| | Sepicide ™ HB: | 0.3% |
| | Sepicide ™ CI: | 0.21% |
| | Parsol ™ MCX: | 5.0% |
| | Titanium oxide-coated mica | 2.0% |
| | Lactic acid: | q.s. pH = 6.5 |

### Example 31

Sunless Tanning Emulsion

FORMULA

| | | |
|---|---|---|
| A | Lanol ™ 99: | 15% |
| | Montanov ™ 68: | 5.0% |
| | Parsol ™ MCX: | 3.0% |
| B | Water: | q.s. for 100% |
| | Dihydroxyacetone: | 5.0% |
| | Monosodium phosphate: | 0.2% |
| C | Composition 1: | 0.5% |
| D | Fragrance: | 0.3% |
| | Sepicide ™ HB: | 0.8% |
| | NaOH: | q.s. pH = 5. |

The characteristics of the products used in the preceding examples are as follows:

Montanov™ 68 (cetearyl glucoside, cetearyl alcohol) is a self-emulsifiable composition, such as those disclosed in WO 92/06778, sold by Seppic.

Montanov™ 202 (arachidyl glucoside, arachidyl alcohol + behenyl alcohol) is a self-emulsifiable composition, such as those disclosed in WO 98/17610, sold by Seppic.

Micropearl™ M 305 is a silky water-dispersible powder based on crosslinked methyl methacrylate copolymer.

Micropearl™ M 100 is an ultrafine powder with a very soft feel and with a mattifying action, sold by Matsumo.

Sepicide™ CI, imidazolineurea, is a preservative sold by Seppic.

Pemulen™ TR is an acrylic polymer sold by Goodrich.

Simulsol™ 165 is self-emulsifiable glyceryl stearate, sold by Seppic.

Lanol™ 1688 is an emollient ester with a non-greasy effect sold by Seppic.

Lanol™ 14M and Lanol™ S are consistency factors sold by Seppic.

Sepicide™ HB, which is a mixture of phenoxyethanol, methylparaben, ethylparaben, propylparaben and butylparaben, is a preservative sold by Seppic.

Monteine™ CA is a moisturizing agent sold by Seppic.

Schercemol™ OP is an emollient ester with a non-greasy effect.

Lanol™ P is an additive with a stabilizing effect sold by Seppic.

Sepiperl™ N is a pearlescent agent, sold by Seppic, based on a mixture of alkyl polyglucosides such as those disclosed in WO 95/13863.

Montanov™ S is a pearlescent agent, sold by Seppic, based on a mixture of alkyl polyglucosides such as those disclosed in WO 95/13863.

Pecosil™ PS100 is dimethicone copolyol phosphate, sold by Phoenix.

Lanol™ 99 is isononyl isononanoate, sold by Seppic.

Lanol™ 37T is glyceryl triheptanoate, sold by Seppic.

Sepifeel™ ONE is a mixture of palmitoylproline, magnesium palmitoylglutamate and magnesium palmitoyl-sarcosinate, such as those disclosed in FR 2 787 323.

Solagum™ L is a carrageenan sold by Seppic.

Marcol™ 82 is a liquid paraffin sold by Esso.

Lanol™ 84D is dioctyl malate, sold by Seppic.

Parsol™ MCX is ethylhexyl para-methoxycinnamate, sold by Givaudan.

Eusolex™ 4360 is benzophenone-3, sold by Merck.

Dow Corning™ 245 Fluid is cyclomethicone, sold by Dow Corning.

Lipacide™ PVB is a hydrolysate of palmitoylated wheat proteins is sold by Seppic.

Sepicontrol™ A5 is a capryloylglycine, sarcosine, extract of Cinnamon zylanicum mixture sold by Seppic, such as those disclosed in International Patent Application PCT/FR98/01313 filed on Jun. 23, 1998.

Capigel™ 98 is an acrylates copolymer sold by Seppic.

Lanol™ 2681 is a coconut caprylate/caprate mixture sold by Seppic.

1. Composition comprising an oil phase, an aqueous phase, at least one emulsifying agent of water-in-oil (W/O) type and at least one emulsifying agent of oil-in-water (O/W) type in the form of a self-invertible inverse latex comprising from 20% to 70% by weight and preferably from 25% to 50% by weight of a branched or crosslinked polyelectrolyte, characterized in that the said polyelectrolyte is either a homopolymer based on a monomer having either a partially or completely salified strong acid functional group or a partially or completely salified weak acid functional group, or a copolymer based on at least one monomer having a strong acid functional group copolymerized either with at least one monomer having a weak acid functional group or with at least one neutral monomer, or a copolymer based on at least one monomer having a weak acid functional group copolymerized with at least one neutral monomer, and characterized in that the constituent solvent of the oil phase is chosen from fatty acid esters.

2. Composition as defined in claim 1, in which the constituent solvent of the oil phase is chosen from compounds formula (I):
R₁—(C═O)—O—[[CH₂—CH[O—[C(═O)]ₘ—R₂]—CH₂—O]ₙ—[C(═O)]ₚ]_{q}—R₃ (I)
in which:
R₁ represents a saturated or unsaturated and linear or branched hydrocarbonaceous chain comprising from 7 to 30 carbon atoms,
R₂ represents, independently of R₁, a hydrogen atom or saturated or unsaturated and linear or branched hydrocarbonaceous chain comprising from 7 to 30 carbon atoms,
R₃ represents, independently of R₁ or of R₂, a hydrogen atom or saturated or unsaturated and linear or branched hydrocarbonaceous chain comprising from 1 to 30 carbon atoms,
m, n, p and q are, independently of one another, equal to 0 or to 1, it being understood that, when R₃ represents a hydrogen atom, q is other than 0.

3. Composition as defined in claim 2, for which, in the formula (I), R₁, R₂ and R₃ represent, independently of one another, a radical chosen from the heptyl, octyl, nonyl, decyl, undecyl, dodecyl, tridecyl, tetradecyl, pentadecyl, hexadecyl, heptadecyl, octadecyl, nonadecyl, icosyl, unicosyl, docosyl, heptadecenyl, icosenyl, unicosenyl, docosenyl or heptadecadienyl or decenyl radicals.

4. Composition as defined in claim 3, for which, in formula (I), the R₁—C(═O)— group represents one of the octanoyl (caprylyl), decanoyl, undecylenoyl, dodecanoyl (lauroyl), tetradecanoyl (myristyl), hexadecanoyl (palmitoyl), octadecanoyl (stearyl), icosanoyl (arachidoyl), docosanoyl (behenoyl), 8-octadecenoyl (oleyl), icosenoyl (gadoloyl), 13-docosenoyl (erucyl), 9,12-octadecadienoyl (linoleoyl) or 9,12,15-octa-decatrienoyl (linolenoyl) radicals.

5. Composition as defined in any one of claims 2 to 4, for which the constituent solvent of the oil phase of the inverse latex is a compound of formula (Ia):
R₁—(C═O)—O—CH₂—CH[O—[C(═O)]ₘ—R₂]—CH₂—O—[C(═O)]ₚ—R₃ (Ia)
corresponding to the formula (I) in which q and n are equal to 1, or a mixture of compounds of formulae (Ia).

6. Composition as defined in claim 5, for which the constituent solvent of the oil phase of the inverse latex is a compound of formula (Ia₁)
R₁—(C═O)—O—CH₂—CH(OH)—CH₂—OH (Ia₁)
corresponding to the formula (Ia) in which m and p are equal to 0 and R₂ and R₃ represent a hydrogen atom.

7. Composition as defined in claim 5, for which the constituent solvent of the oil phase of the inverse latex is a compound of formula (Ia₂)
R₁—(C═O)—O—CH₂—CH(OH)—CH₂—O—C(═O)—R₃ (Ia₂)
corresponding to the formula (Ia) in which p is equal 1, m is equal to 0 and R₂ represents a hydrogen atom.

8. Composition as defined in claim 5, for which the constituent solvent of the oil phase of the inverse latex is a compound of formula (Ia₃):
R₁—(C═O)—O—CH₂—CH[O—C(═O)—R₂]—CH₂—O—C(═O) —R₃ (Ia₃)
corresponding to the formula (Ia) in which m and p are equal to 1.

9. Composition as defined in claims 5 to 8, for which the constituent solvent of the oil phase of the inverse latex is a mixture of compounds of formulae (Ia₁), (Ia₂) and/or (Ia₃).

10. Composition as defined in any one of claims 2 to 4, for which the constituent solvent of the oil phase of the inverse latex is a compound of formula (Ib):
R₁—(C═O)—O—R₃ (Ib)
corresponding to the formula (I) in which q is equal to 0, or a mixture of compounds of formulae (Ib).

11. Composition as defined in claim 10, for which the constituent solvent of the oil phase of the inverse latex is octyl palmitate.

12. Composition as defined in claims 5 to 11, for which the constituent solvent of the oil phase of the inverse latex is a mixture of at least one compound of formula (Ib) and of at least one compound of formulae (Ia).

13. Composition as defined in any one of claims 1 to 12, in which the emulsifying agent or agents of the water-in-oil type are chosen from sorbitan monooleate, sorbitan isostearate or sorbitan oleate ethoxylated with 5 mol of ethylene oxide.

14. Composition as defined in any one of claims 1 to 13, in which the emulsifying agent or agents of the water-in-oil type are chosen from sorbitan oleate ethoxylated with 20 mol of ethylene oxide, ethoxylated castor oil comprising 40 mol of ethylene oxide, ethoxylated sorbitan laurate comprising 20 mol of ethylene oxide, or ethoxylated lauryl alcohol comprising 7 mol of ethylene oxide.

15. Composition as defined in any one of claims 1 to 14, in which the emulsifying agent or agents of the oil-in-water type are chosen [lacuna] the compounds of formula (II):
R₄—O—[CH(R₅)—CH₂—O]ₙ—(G)ₓ—H (II)
in which R₄ represents a saturated or unsaturated and linear or branched hydrocarbonaceous radical comprising from 1 to 30 carbon atoms, R₅ represents a hydrogen atom or an alkyl radical comprising 1 or 2 carbon atoms, G represents the residue of a saccharide, x represents a decimal number between 1 and 5 and n is equal either to zero or to an integer 9.

16. Composition as defined in claim 15, for which, in the formula (II), x is between 1 and 3, more particularly between 1.05 and 2.5, very particularly between 1.1 and 2.0 and preferably less than or equal to 1.5.

17. Composition as defined in either of claims 15 and 16, for which, in the formula (II), G represents the glucose residue or the xylose residue and n is equal to 0.

18. Composition as defined in any one of claims 15 to 17, for which, in the formula (II), R₄ represents a radical comprising from 8 to 18 carbon atoms and more particularly an octyl, decyl, undecyl, dodecyl, tetradecyl or hexadecyl radical, the said radicals being linear or branched.

19. Composition as defined in any one of claims 1 to 18, for which the strong acid functional group of the monomer comprising it is the sulphonic acid functional group or the phosphonic acid functional group, partially or completely salified, and the monomer is preferably 2-methyl-2-[(1-oxo-2-propenyl)amino]-1-propanesulphonic acid, partially or completely salified in the form of an alkali metal salt, such as, for example, the sodium salt or the potassium salt, of the ammonium salt, of a salt of an aminoalcohol, such as, for example, the monoethanolamine salt, or of an amino acid salt, such as, for example, the lysine salt.

20. Composition as defined in any one of claims 1 to 19, for which the weak acid functional group of the monomer comprising it is the carboxylic acid functional group and the said monomer is preferably chosen from partially or completely salified acrylic acid, methacrylic acid, itaconic acid or maleic acid.

21. Composition as defined in any one of claims 1 to 20, for which the neutral monomer is chosen from 2-hydroxyethyl acrylate, 2,3-dihydroxypropyl acrylate, 2-hydroxyethyl methacrylate, 2,3-dihydroxypropyl methacrylate or an ethoxylated derivative with a molecular weight of between 400 and 1000 of each of these esters.

22. Composition as defined in one of claims 1 to 18, in which the polyelectrolyte is a homopolymer of acrylic acid partially or completely salified in the form of the sodium salt or of the ammonium salt.

23. Composition as defined in one of claims 1 to 18, in which the polyelectrolyte is a copolymer of partially or completely salified 2-methyl-2-[(1-oxo-2-propenyl)-amino]-1-propanesulphonic acid (a) and of 2-hydroxyethyl acrylate (b) in an (a)/(b) molar ratio of between 30/70 and 90/10 and very particularly 50/50 and 90/10.

24. Composition as defined in claim 23, in which the polyelectrolyte is a copolymer of the sodium salt or of the ammonium salt of 2-methyl-2-[(1-oxo-2-propenyl)amino]-1-propanesulphonic acid (a₁) and of 10% to 40% of 2-hydroxyethyl acrylate (b) in an (a₁)/(b) molar ratio of between 60/40 and 90/10.

25. Composition as defined in one of claims 1 to 18, in which the polyelectrolyte is a copolymer of the sodium salt, of the ammonium salt, of the monoethanolamine salt or of the lysine salt of 2-methyl-2-[(1-oxo-2-propenyl) amino]-1-propanesulphonic acid (a₁) and of acrylic acid partially or completely salified in the form of the sodium salt, of the ammonium salt, of the monoethanolamine salt or of the lysine salt (c₁) in an (a₁)/(c₁) molar ratio of between 30/70 and 90/10 and very particularly between 30/70 and 45/55.

26. Composition as defined in one of claims 1 to 18, in which the polyelectrolyte is a copolymer of the sodium salt or of the ammonium salt of 2-methyl-2-[(1-oxo-2-propenyl) amino]-1-propanesulphonic acid (a₂) and of acrylamide (d) in an (a₂)/(d) molar ratio of between 50/50 and 30/70.

27. Composition as defined in any one of claims 1 to 26, characterized in that the polyelectrolyte is crosslinked and/or branched with a diethylenic or polyethylenic compound in the molar proportion, expressed with respect to the monomers employed, of 0.005% to 1% and preferably of 0.01% to 0.5% and more particularly of 0.1% to 0.25%.

28. Composition as defined in claim 27, characterized in that the crosslinking agent and/or branching agent is chosen from diallyloxyacetic acid or one of its salts, such as sodium diallyloxyacetate, ethylene glycol dimethacrylate, ethylene glycol diacrylate, diallylurea, trimethylolpropane triacrylate, methylenebis (acrylamide), triallylamine or a mixture of these compounds.

29. Composition as defined in any one of claims 1 to 28, characterized [lacuna] that it comprises from 4% to 10% by weight of emulsifying agents.

30. Composition as defined in claim 29, in which from 20% to 50% and more particularly from 25% to 40% of the total weight of the emulsifiers are of the water-in-oil type and from 80% to 50% and more particularly from 75 to 60% by weight are of the oil-in-water type.

31. Composition as defined in any one of claims 1 to 30, characterized in that the oil phase represents from 15% to 40% and preferably from 20% to 25% of its total weight.

32. Composition as defined in any one of claims 1 to 31, characterized in that it additionally comprises one or more additives chosen from complexing agents, transfer agents or chain-limiting agents.

33. Cosmetic, dermocosmetic, dermopharmaceutical or pharmaceutical composition, characterized in that it comprises from 0.1% to 10% by weight of the composition as defined in any one of claims 1 to 32.

34. Cosmetic, dermocosmetic, dermopharmaceutical or pharmaceutical composition as defined in claim 33, in the form of a milk, of a lotion, of a gel, of a cream, of a soap, of a foam bath, of a balm, of shampoo or of a conditioner.

35. Use of a composition as defined in one of claims 1 to 34 in preparing cosmetic, dermocosmetic, dermopharmaceutical or pharmaceutical compositions.
